(19) United States
(12) Patent Application Publication
(10) Pub. No.: US 2017/0130823 A1
(43) Pub. Date: May 11, 2017

(54) INTERMEDIATE PLATE AND CONTROL UNIT FOR FLUID OPERATED CONSUMING DEVICES

(71) Applicant: ElringKlinger AG, Dettingen (DE)

(72) Inventors: Jochen Schoellhammer, Dettingen (DE); Kristian Goehl, Reutlingen (DE)

(21) Appl. No.: 15/405,981

(22) Filed: Jan. 13, 2017

Related U.S. Application Data
(63) Continuation of application No. PCT/EP2015/065972, filed on Jul. 13, 2015.

(30) Foreign Application Priority Data
Jul. 15, 2014 (DE) 102014109937.0

(51) Int. Cl. F16H 61/00; F16J 15/08

(52) U.S. Cl. CPC F16H 61/0009; F16J 15/0806

(57) ABSTRACT

In order to improve an intermediate plate for the sealing of mutually opposed sealing faces of housing parts of a control unit for fluid-operated consuming devices, comprising two seal surface regions of at least one seal layer which face toward the respective sealing faces and are placeable sealingly thereon, so that a lasting and reliable sealing between the seal surface regions and the sealing faces is ensured, it is proposed that at least one of the seal surface regions is formed by an exposed metal coating which is capable of sliding relative to the sealing faces, for direct contact with the sealing faces.

### CROSS-REFERENCE TO RELATED PATENT APPLICATION

This application is a continuation of International application No. PCT/EP2015/065972 filed on Jul. 13, 2015.

This patent application claims the benefit of International application No. PCT/EP2015/065972 of Jul. 13, 2015 and German application No. 10 2014 109 937.0 of Jul. 15, 2014, the teachings and disclosure of which are hereby incorporated in their entirety by reference thereto.

### BACKGROUND OF THE INVENTION

The invention relates to an intermediate plate for the sealing of mutually opposed sealing faces of housing parts of a control unit for fluid-operated consuming devices, in particular a transmission control unit, comprising two seal surface regions of at least one seal layer which face toward the respective sealing faces and are placeable sealingly thereon.

In intermediate plates of this type the problem exists that typically the seal surface regions are provided with elastomer coatings for sealing, which become damaged during operation of the control unit, so that a sealing between the seal surface regions and the sealing faces become damaged during the operating life of the control unit.

It is therefore an object of the invention to improve an intermediate plate and a control unit with an intermediate plate of this type such that a lasting and reliable sealing between the seal surface regions and the sealing faces is ensured.

### SUMMARY OF THE INVENTION

This object is achieved according to the invention in an intermediate plate of the type described in the introduction in that at least one of the seal surface regions is formed by an exposed metal coating which is capable of sliding relative to the sealing faces, for direct contact with the sealing faces.

The advantage of the solution according to the invention lies therein that a metal coating of this type with sliding capability has the advantage that it is subject to lower abrasion and lower occurrences of wear than an elastomer layer and therefore ensures both the lasting sliding capability relative to the respective sealing face and also the sealing with the respective sealing face.

A particularly favourable solution provides that the metal coating is formed from a material the Brinell hardness of which is less than 50 HB.

In order to achieve a sufficient stability of the metal coating, it is preferably provided that the metal coating has a Brinell hardness that is greater than 10 HB.

In order to obtain a sufficiently great stability of the metal coating, it is preferably provided that the metal coating has a shear strength that is greater than 2 MPa (megapascal).

The material of the metal coating can have many kinds of composition.

The material of the metal coating is preferably a soft metal.

Such soft metals are, for example, pure metals such as aluminium, copper, tin or zinc.

Preferably, however, alternatively to the pure metals, metal alloys can also be used, for example, aluminium alloys, copper alloys or tin alloys or lead alloys, for example, copper-tin alloys, lead-tin alloys, brass alloys.

Particularly favourable herein for the metal coating are materials which are also used as sliding bearing materials.

With regard to the layer thicknesses of the metal coating according to the invention, no detailed information has yet been given.

An advantageous solution provides that the metal coating has a layer thickness that is 1 μm or greater, or better 2 μm or greater.

With regard to the effectiveness of the metal coating, it is also advantageous, however, if the layer thickness thereof is limited.

For this reason, it is provided that the metal coating has a layer thickness that is 10 μm or less, or better 8 μm or less.

In the solution according to the invention, the metal coating can be applied onto the material of the seal layer.

With a direct application, a state can preferably even be achieved in which the metal coating partially diffuses into the material of the seal layer in order to create as intimate a connection as possible between the metal coating and the seal layer.

Another advantageous solution provides that the metal coating is applied onto a hard coating which itself is applied onto the seal layer, that is, that in this case, the hard coating forms an intermediate layer between the material of the seal layer and the metal coating.

Such a hard coating has the advantage that this offers safety for the case that the metal coating is worn off during the use of the intermediate layer, so that in this case, the hard coating protects the material of the seal layer against direct contact with the sealing faces.

The hard coating preferably comprises materials from the group of ceramics or metals, for example, the following materials: DLC, TiN, SiC, Cr, hard bronze.

Preferably, the hard coating is formed such that it has a Brinell hardness that is greater than 100 HB.

The layer thickness of the hard coating is preferably 1 μm or more.

Furthermore, the hard coating is preferably so formed that its layer thickness is 10 μm or less.

In particular, it is favourable if the layer thickness of the hard coating is less than the layer thickness of the metal coating.

In particular it is favourable if the hard coating is applied directly onto the seal layer without an intermediate layer.

With respect to the seal layer, the most varied of solutions are conceivable.

For example, the seal layer could be produced from many kinds of materials.

It is particularly favourable if the seal layer is a metallic seal layer.

In the case, in particular, of a metallic seal layer it is preferably provided that the seal layer is formed by a sheet metal layer provided with a bead.

In this case, a bead crest forms the seal surface region used for sealing with the sealing face.

For this reason, it is preferably provided that the exposed metal coating is arranged at least in the region of a bead crest facing toward a sealing face.

Alternatively thereto, it is provided that the seal layer is formed by a flat sheet metal layer extending in a plane parallel to the sealing faces.

In this case, it is preferably provided that the seal layer comprises seal surfaces extending parallel to the sealing faces.

The invention further relates to a control unit for fluid-operated consuming devices, comprising two housing parts with sealing faces facing toward one another, between which is arranged an intermediate plate which abuts the sealing faces with seal surface regions in a fluid-tight manner.

In such a control unit, according to the invention, the intermediate plate is formed in accordance with one or more of the above features.

Preferably, in such a control unit, it is provided that the sealing faces have a mean surface roughness that is less than 10 μm, in order particularly in relation to the metal coating, to enable a sufficiently good sealing with sufficiently good sliding properties.

It is also particularly favourable if the seal surface regions of the exposed metal coatings form, with the sealing faces, a material pairing the coefficient of sliding friction of which is 0.6 or less, or better is 0.5 or less in order firstly to obtain the required sliding properties and secondly to achieve a sufficiently good sealing.

With respect to the sealing faces of the housing parts, no further details have so far been given.

An advantageous solution provides that the sealing faces of the housing parts are formed by exposed metal surfaces.

Preferably, the metal surfaces forming the sealing faces are aluminium surfaces or steel surfaces.

Particularly favourably, such a solution can be realised if the housings themselves are made of metal, that is they are themselves made of aluminium or steel.

Further features and advantages of the invention are the subject matter of the following description and of the representation in the drawings of some exemplary embodiments.

### BRIEF DESCRIPTION OF THE DRAWINGS

FIG. 1 shows a perspective exploded representation of a control unit according to the invention with two housing parts, the sealing faces of which face toward one another and between which is arranged an intermediate plate according to the invention;

FIG. 2 shows a representation expanded in the height direction of a partial section along the line 2-2 of FIG. 1 in a first exemplary embodiment of a control unit according to the invention;

FIG. 3 shows a representation of a section similar to FIG. 2 in a second exemplary embodiment of a control unit according to the invention;

FIG. 4 shows a representation of a section similar to FIG. 2 in a third exemplary embodiment of a control unit according to the invention;

FIG. 5 shows a representation of a section similar to FIG. 2 in a fourth exemplary embodiment of a control unit according to the invention;

FIG. 6 shows a representation of a section similar to FIG. 2 in a fifth exemplary embodiment of a control unit according to the invention, and

FIG. 7 shows a representation of a section similar to FIG. 2 in a sixth exemplary embodiment of a control unit according to the invention.

### DETAILED DESCRIPTION OF THE INVENTION

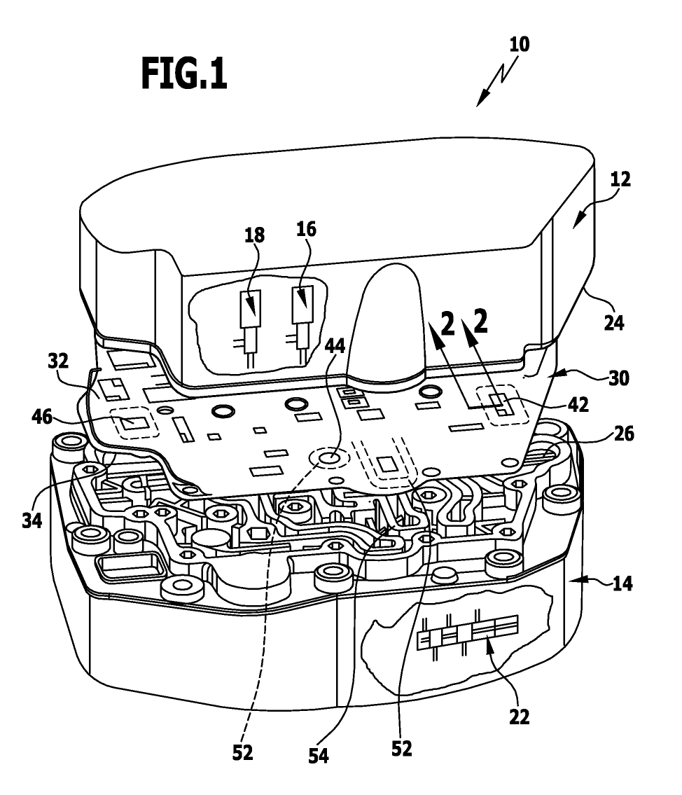

A control unit for fluid-operated consuming devices shown schematically in FIG. 1 and identified overall as 10, for example for fluid-operated transmission units, in particular transmission units for motor vehicles, comprises a first housing part 12, in particular made of metal and a second housing part 14, in particular made of metal, wherein there are arranged, for example, in the first housing part valves 16, 18 and in the second housing part 14, for example, a slider 22, which respectively control or regulate a flow of fluid in the respective housing part 12, 14.

The two housing parts 12, 14 have channel sides 24 and 26 facing one another which are configured such that the fluid can transfer from the one housing part 12, 14 into the respective other housing part 14, 12.

Inserted between these channel sides 24 and 26 of the housing parts 12, 14 is an intermediate plate identified overall as 30, which abuts the channel side 24 of the first housing part 12 with a first side 32 and abuts the channel side 26 of the second housing part 14 with a second side 34 and closes imperviously with the channel sides 24 and 26, wherein passages in the intermediate plate 30, for example, the passages 42, 44 and 46 and possibly further passages are provided, through which a transfer of the fluid from one housing part 12, 14 into the other housing part 14, 12 takes place.

Herein, some of the passages, for example, the passages 42 and 46 enable an unhindered transfer of the fluid from one housing part 12, 14 into the other housing part 14, 12 and additionally thereto, some of the passages, for example, the passage 44, serve as a functional element to influence the fluid transferring from one housing part 12, 14 into the other housing part 14, 12, wherein by means of a passage 44 of this type, for example, a specifically adaptable throttle effect can be achieved for controlling sequences, in particular temporal sequences in gear change processes.

For functionally reliable sealing between the channel sides 24 and 26 of the housing parts 12 and 14 and the intermediate plate 30, provided on the intermediate plate 30 are seal surface regions 52 extending round the passages 42, 44, 46 or looping around them closely or at a spacing which, in the assembled state of the control unit, abut correspondingly extending sealing faces 54 of the channel sides 24, 26.

The sealing faces 54 of the channel sides 24, 26 are, for example, exposed metal surfaces which are processed and are preferably processed so that they have a roughness that is less than 10 μm.

It is particularly favourable if the mean surface roughness Rz of the metal surfaces is in the region of 10 μm or less.

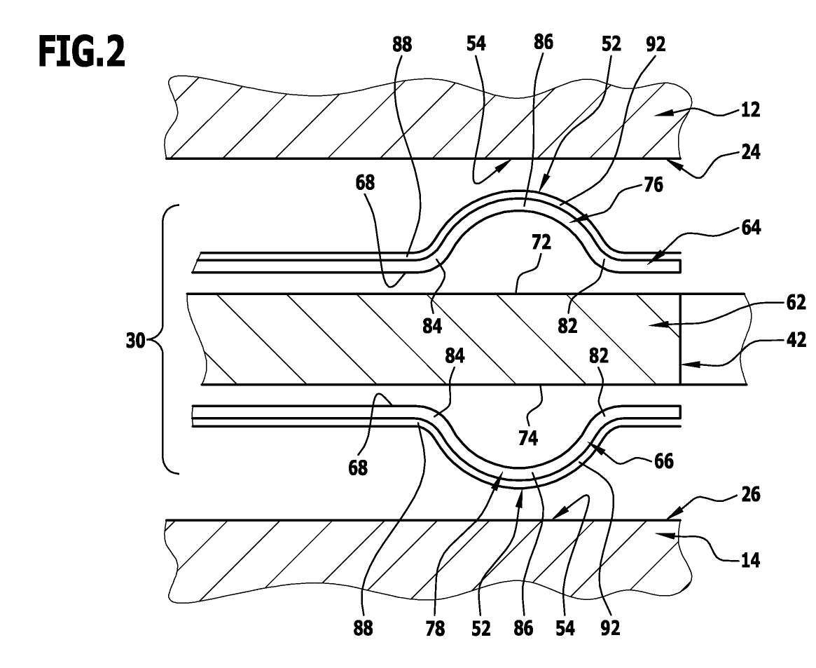

In a first exemplary embodiment shown in FIG. 2 of an intermediate plate 30 according to the invention, it is constructed from a carrier plate 62 which is made, for example, of metal and carries on each side a metallic seal layer 64, 66, which layers respectively abut mutually opposed surfaces 72, 74 of the carrier plate 62.

The seal layers 64 and 66 abut, with their seal layer undersides 68 facing toward the carrier plate 62, the mutually opposed surfaces 72 and 74 of the carrier plate and, with the seal layer underside 68, imperviously seal the surfaces 72 and 74 of the carrier plate 62.

Preferably, the seal layers 64 and 66 are connected to the carrier plate 62 such that the seal layers 64 and 66 cannot move parallel to the extent of the carrier plate 62 and thus, in the assembled state, no sliding movement occurs between the seal layers 64 and 66 and the carrier plate 62.

The seal layers 64, 66 are preferably also formed from a metal layer, in particular a sheet metal and, to improve the sealing within the respective seal surface region 52, have beads 76 and 78 which are preferably formed as full beads, the respective bead feet 82, 84 of which abut the surfaces 72, 74 of the carrier plate 62, whereas the respective bead crests 86 face toward the respective sealing faces 54 of the channel sides 24, 26, so that particularly in the region of the bead crests 86, the seal surface regions 52 are formed which abut the seal faces 54 in a fluid-tight manner.

The seal layers 64, 66 are preferably made of steel.

A placement of the seal layers 64, 66 with their surface regions 52 on the sealing faces 54 would however not result in a sufficiently fluid-tight sealing at high pressures due to the roughness of the sealing faces 54.

For this reason, the seal layers 64, 66 are each provided in the seal surface regions 52 on their seal layer upper side 88 with a metal coating 92 which, in the first exemplary embodiment, at least in the region of the bead crests 86, can sealingly abut directly against the sealing face 54 of the respective channel side 24, 26 on one side and is capable of sliding on the other side relative to the respective sealing face 54, so that the respective seal layer 64, 66 with the respective seal surface region 52 which, in this exemplary embodiment lies at least in the region of the bead crests 86, due to thermal or mechanical influences, can carry out a sliding movement relative to the sealing faces 54 of the channel sides 24, 26 without the sealing between the seal surface regions 52 and the respective sealing region 54 deteriorating.

Preferably, the metal coating 92 is herein made of a soft metal and preferably has a Brinell hardness of less than 50 HB.

Such materials suitable for the metal coating 92 are either aluminium or copper or tin or zinc or metal alloys such as for example copper-tin alloys, lead-tin alloys, aluminium alloys or brass alloys.

The advantage of such soft metal alloys lies therein that, with these, material pairings are produced between the seal surface regions 52 and the sealing faces 54 the coefficient of sliding friction of which is 0.5 or less, so that thereby, a sufficiently good sliding of the seal surface regions 52 relative to the sealing faces 54 is possible and simultaneously, a good sealing arises between the seal surface regions 52 and the sealing faces 54.

In particular, the metal coatings 92 are formed so that they have a shear strength that is greater than 2 MPa.

The layer thickness of the metal coating 92 for forming the seal surface regions 52 is, for example, in the region of values of 1 μm and more, preferably values of 2 μm and more.

As a maximum, the layer thickness of the metal coating 92 is 10 μm or less, preferably 8 μm or less.

With such layer thicknesses of the metal coating 92, there results firstly a sufficiently good sealing with improved sliding properties between the seal surface regions 52 and the sealing faces 54, which also have a long service life so that both the sliding properties and also the sealing during a pre-determined lifespan of the control unit 10 according to the invention are retained.

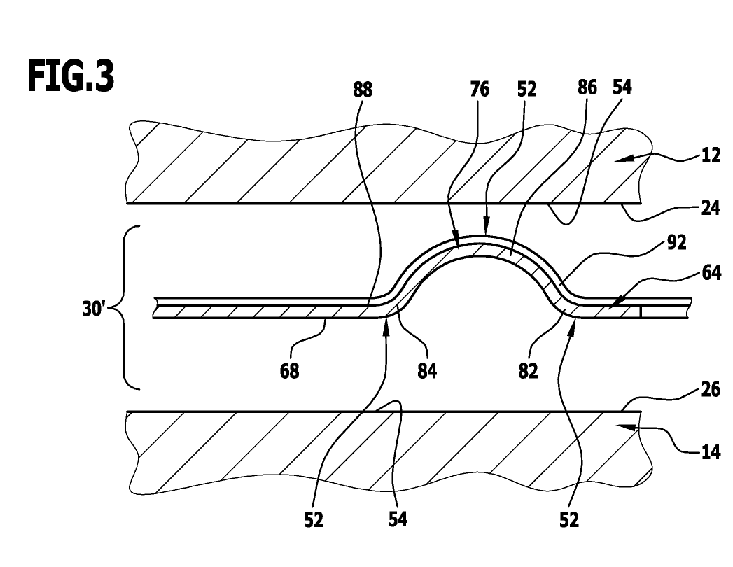

In a second simplified exemplary embodiment shown in FIG. 3, the intermediate plate 30′ comprises only a single seal layer 64 with the bead 76 which is provided in the region of the bead crest 86 in order to form the seal surface 72 with the metal coating 92, which is formed in the same way as in the first exemplary embodiment.

Furthermore, the seal layer 64 in the second exemplary embodiment is formed so that it forms the seal surface regions 52 in the region of its bead feet 82, 84, although these do not carry any metal coating 92, but rather abut the channel side 26 with their seal layer underside 68 on the sealing face 54.

Furthermore, the second exemplary embodiment, insofar as it has the same elements as the first exemplary embodiment, is provided with the same reference signs so that with regard to these elements, reference can be made to the description of the first exemplary embodiment.

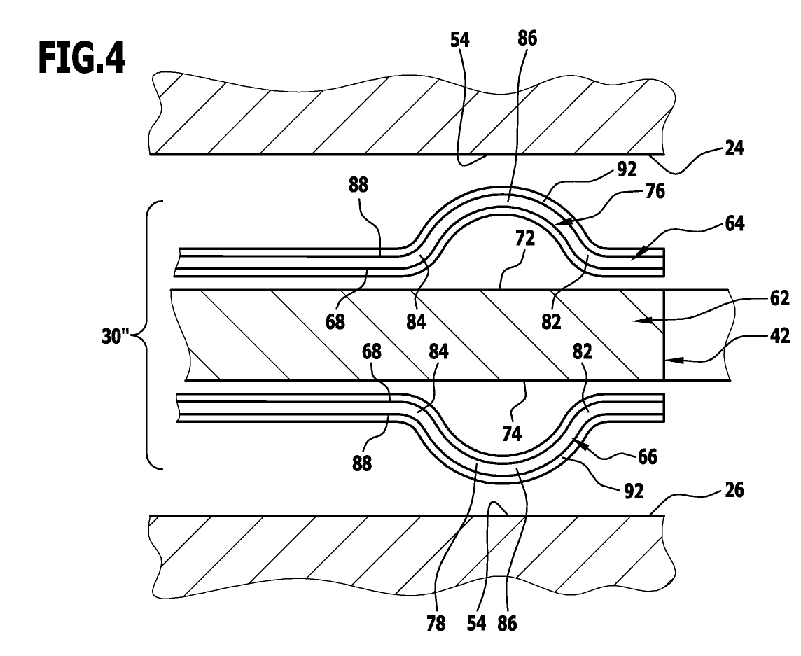

In a third exemplary embodiment of a control unit according to the invention shown in FIG. 4, the seal layers 64 and 66 are not only provided with the metal coating 92 on the seal layer upper side 88, but also on the seal layer underside 68 which lies on the corresponding surface 72, 74 of the carrier plate 62, so that thereby, the sealing and sliding properties can also be improved in the region of the bead feet 82 and 84 of the respective bead 76 and 78 and thus the sealing between the seal layers 64 and 66 and the carrier plate 62 is also improved.

Otherwise, the third exemplary embodiment is formed in the same way as the second exemplary embodiment so that reference can be made to the entire content of the description regarding the second exemplary embodiment.

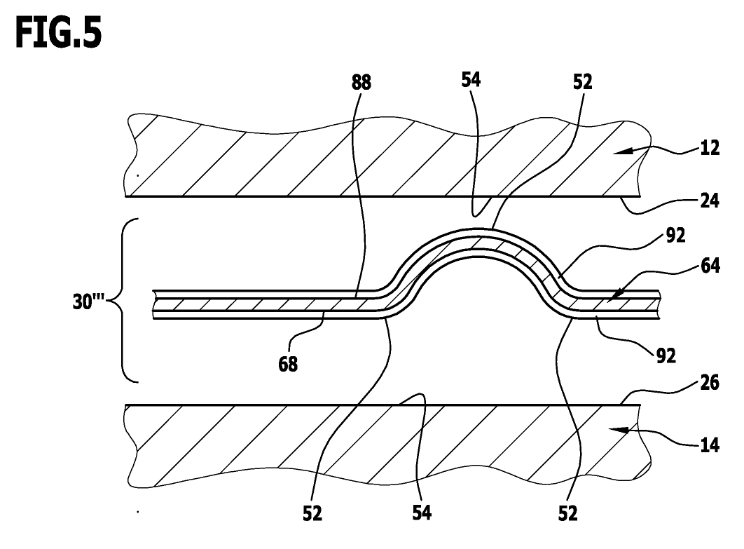

In a fourth exemplary embodiment, shown in FIG. 5, which represents a modification of the second exemplary embodiment, the single seal layer 64 is provided both on the seal layer underside 68 and also on the seal layer upper side 88 with the metal coating 92 which thereby improves both the sealing between the only seal layer 64 and the sealing face 54 of the channel side 24 as well as the sealing face 54 of the channel side 26 and permits a relative sliding of the sealing faces 54 on both sides of the seal layer 64 relative to the seal surfaces 52 of the intermediate layer 30″.

Otherwise, the further features of the fourth exemplary embodiment are identical to those of the second and first exemplary embodiment, so that for the same elements, the same reference signs are used and reference is made in this regard to the description regarding the second and first exemplary embodiments.

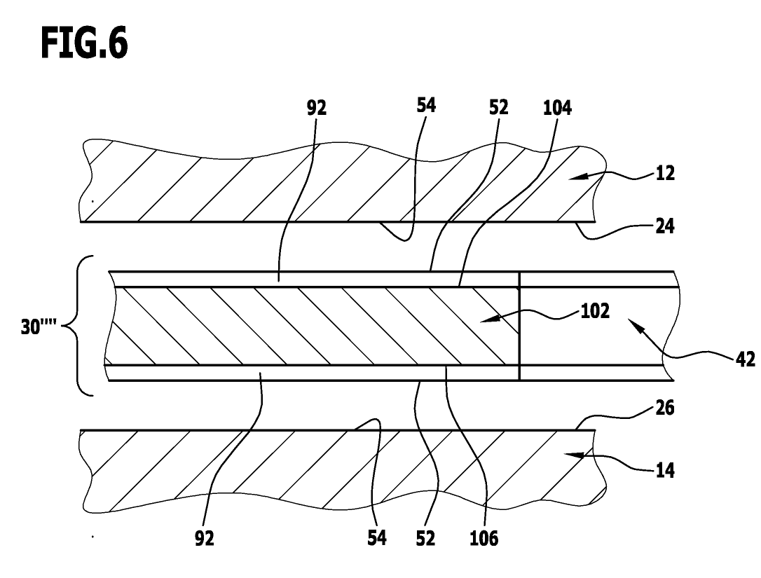

In a fifth exemplary embodiment, shown in FIG. 6, a flat metal layer is provided as the only seal layer 102, which has surfaces 104 and 106 which preferably extend parallel to the sealing faces 54.

Such a flat seal layer 102 is also provided on its mutually opposed surfaces 104 and 106 facing one another with a metal coating 92 which is constructed and configured according to the above exemplary embodiments and forms the seal face regions 52 which abut the sealing faces 54 of the channel sides 24 and 26 for sealing.

Herein, the metal coating 92 can extend over the whole surfaces 104 and 106 of the seal layer 102 or only over the sub-regions of the seal layer 102 in which a sealing with the sealing faces 54 is to take place.

Otherwise, all those elements of the fifth exemplary embodiment which are identical to those of the above exemplary embodiments are provided with the same reference symbols, so that with regard to the description, reference can be made in full to the description regarding the above exemplary embodiments.

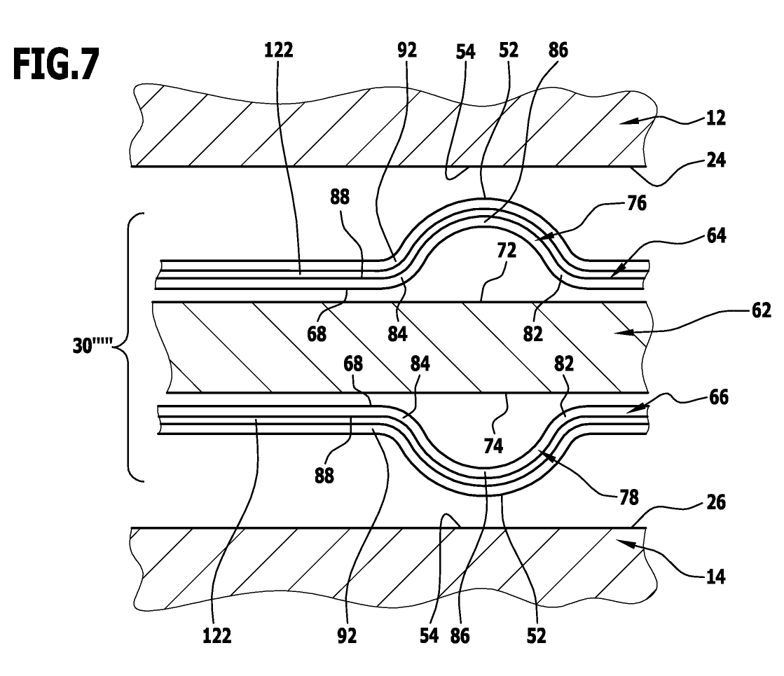

In a sixth exemplary embodiment shown in FIG. 7 which represents a modification of the first exemplary embodiment, the metal coating 92 is not applied directly onto the seal layer upper sides 88 of the seal layers 64 and 66, rather the seal layer upper sides 88 are provided with a hard coating 122, each of which carry the metal coatings 92.

The hard coatings 122 preferably have a Brinell hardness of greater than 100 HB and serve to protect the material of the seal layers 64 and 66 in case removal of the metal coating 92 arises on the seal surface regions 52 due to a long usage period thereof.

It is also possible to use the hard coating 122 as an adhesion-promoting layer between the respective seal layer 64, 66 and the metal coating 92 so that in this way, the adhesion of the metal coating 92 on the seal layer 64, 66 can be improved.

The hard coating 122 preferably has a thickness of 1 μm or more.

Furthermore, the hard coating 122 preferably has a thickness of 10 μm or less.

As materials for the hard coating 122, for example, DLC, TiN, SiC, Cr or hard bronze are provided.

Such a hard coating 122 between the respective seal layer and the metal coating 92 can also be used in all the other exemplary embodiments, that is particularly the second to fifth exemplary embodiments, between the respective seal layer 62, 64 and the metal coating 92 and has the same advantages as were described in connection with the sixth exemplary embodiment.

Otherwise, in the sixth exemplary embodiment, all those elements which are identical to those of the above exemplary embodiments are also provided with the same reference signs, so that, in respect of the description thereof, reference can be made in full to the description regarding the previous exemplary embodiments.

1. Intermediate plate for the sealing of mutually opposed sealing faces of housing parts of a control unit for fluid-operated consuming devices, comprising two seal surface regions of at least one seal layer which face toward the respective sealing faces and are placeable sealingly thereon, at least one of the seal surface regions is formed by an exposed metal coating which is capable of sliding relative to the sealing faces, for direct contact with the sealing faces.

2. Intermediate plate according to claim 1, wherein the metal coating is formed from a material the Brinell hardness of which is less than 50 HB.

3. Intermediate plate according to claim 1, wherein the metal coating has a shear strength that is greater than 2 MPa.

4. Intermediate plate according to claim 1, wherein the material of the metal coating comprises a metal or a metal alloy.

5. Intermediate plate according to claim 1, wherein the metal coating has a layer thickness that is 1 μm or greater, or better 2 μm or greater.

6. Intermediate plate according to claim 1, wherein the metal coating has a layer thickness that is 10 μm or less, or better 8 μm or less.

7. Intermediate plate according to claim 1, wherein the metal coating is applied onto a hard coating.

8. Intermediate plate according to claim 7, wherein the hard coating has a Brinell hardness that is greater than 100 HB.

9. Intermediate plate according to claim 7, wherein the hard coating has a layer thickness that is 1 μm or greater, or better 2 μm or greater.

10. Intermediate plate according to claim 7, wherein the metal coating has a layer thickness that is 10 μm or less, or better 8 μm or less.

11. Intermediate plate according to claim 7, wherein the layer thickness of the hard coating is less than the layer thickness of the metal coating.

12. Intermediate plate according to claim 7, wherein the hard coating is applied directly onto the seal layer.

13. Intermediate plate according to claim 1, wherein the seal layer is a metallic seal layer.

14. Intermediate plate according to claim 13, wherein the seal layer is formed by a sheet metal layer provided with a bead.

15. Intermediate plate according to claim 14, wherein the exposed metal coating is arranged at least in the region of a bead crest facing toward one of the sealing faces.

16. Intermediate plate according to claim 1, wherein the seal layer is formed by a sheet metal layer extending in a plane parallel to the sealing faces.

17. Intermediate plate according to claim 16, wherein the seal layer comprises seal surface regions extending parallel to the sealing faces.

18. Control unit for fluid-operated consuming devices, comprising two housing parts with sealing faces facing toward one another, between which is arranged an intermediate plate which abuts the sealing faces with seal surface regions in a fluid-tight manner, the intermediate plate is configured according to claim 1.

19. Control unit according to claim 18, wherein the sealing faces have a mean surface roughness that is less than 10 μm.

20. Control unit according to claim 18, wherein the exposed metal coating in the seal surface regions forms, with the sealing faces, a material pairing the coefficient of sliding friction of which is 0.6 or less, or better 0.5 or less.

21. Control unit according to claim 18, wherein the sealing faces of the housing parts are formed by exposed metal surfaces.
